(19) United States
(12) Patent Application Publication
(10) Pub. No.: US 2004/0038690 A1
(43) Pub. Date: Feb. 26, 2004

(54) Method for approving services using mobile communication terminal

(75) Inventors: Sun-Gi Lee, Seoul (KR); Woo-Yong Lee, Yongin-shi (KR); Seung-Ki Cho, Seoul (KR); Ik-Hyun Cho, Seoul (KR); Kook-Jun Kim, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/369,830

(22) Filed: Feb. 19, 2003

(30) Foreign Application Priority Data
Aug. 20, 2002 (KR) P2002-49331

(51) Int. Cl. H04Q 7/20

(52) U.S. Cl. 455/466

(57) ABSTRACT

A method for approving services using a mobile communication terminal is disclosed. The method provides an online service to a minor under approval from a guardian of the minor, thereby preventing the minor from accessing harmful information or excessively using a chargeable service. Through the method, an approved amount of payment for the use of the services can be made.

### PRIORITY

This application claims priority to an application entitled “METHOD FOR APPROVING SERVICES USING MOBILE COMMUNICATION TERMINAL”, filed in the Korean Industrial Property Office on Aug. 20, 2002 and assigned Serial No. 2002-49331, the contents of which are hereby incorporated by reference.

### BACKGROUND OF THE INVENTION

1. Field of the Invention

The present invention relates to a method for approving services using a mobile communication terminal, and more particularly to a method for approving services using a mobile communication terminal when an online service on the Internet and/or a radio payment service are provided.

2. Description of the Related Art

A current mobile communication terminal such as a mobile telephone can perform various supplementary functions. The current mobile communication terminal provides a supplementary SMS (Short Message Service) and other functions capable of changing various settings within the terminal according to a user's environment. Supplementary functions include providing an online service on the Internet and a radio payment service. A description will be given of an online service procedure needed to buy products or contents on the Internet using the mobile communication terminal. When a service user buys the products or contents on the Internet using a mobile communication terminal, the service user orders the products or contents. Thereafter, if the service user inputs information associated with an identification number of the mobile communication terminal, the user's name and the user's social security number, a service-providing server requests a mobile communication subscriber server of a mobile communication service company to authenticate the service user using the information. The mobile communication subscriber server carries out the service user authentication and then transmits a result of the authentication to the service-providing server. In response to the result of the authentication, the service-providing server generates an authentication number using an authentication algorithm and then transmits the authentication number to the mobile communication terminal of the service user using the SMS, etc. If the service user transmits the authentication number to the service-providing server by inputting the authentication number on the Internet, the service-providing server approves the sale of the products and a bill for the purchased product is included in a bill for the use of the mobile communication terminal. The bill for the purchased product is thus charged with the bill for the use of the mobile communication terminal.

The radio payment service being one of supplementary services uses the mobile communication terminal instead of a credit card. In other words, the radio payment service is referred to as a credit card service in that the mobile communication terminal has an RF (Radio Frequency) chip identical to an RF chip mounted on a plastic credit card and a memory storing credit card information of the service user. A radio payment using the mobile communication terminal having the credit card information is made by transmitting contents stored in the RF chip or the credit card information previously stored in the memory to an RF reader through infrared rays. The RF reader requests a credit card subscriber management server to approve the radio payment by transmitting the credit card information to it. The credit card subscriber management server retrieves credit card subscriber information and approves the radio payment if the service user is an approved subscriber.

These online services on the Internet and the radio payment services provide increased convenience to users. With increase in convenience, however, there may also be increase in misuse of such services. For example, there is a possibility that a minor or a person lacking in credit may attempt to purchase products through the provided services. A reckless use of the credit card can create a large number of credit-unworthy customers. Such misuse by a minor or a credit-unworthy customer will become a social problem. Thus, to prevent and mitigate occurrences of such problems, online services and the radio payment services capable of being managed by a guardian of a minor are needed.

### SUMMARY OF THE INVENTION

Therefore, the present invention has been made in view of the above problems, and it is an object of the present invention to provide an authentication method for providing a stable online service and a stable radio payment service using a mobile communication terminal.

It is another object of the present invention to provide an authentication method for preventing a reckless use of an online service and a radio payment service using a mobile communication terminal.

In accordance with an aspect of the present invention, the above and other objects can be accomplished by the provision of an authentication method for providing an online service using a mobile communication terminal in an online service system, the online service system including a service-providing server connected to an Internet network for providing the online service, a service user terminal connected to the Internet network for requesting the service-providing server to provide the online service and using the online service provided from the service-providing server, and a mobile communication subscriber information server connected to a mobile communication network interworked with the Internet network for storing mobile communication subscriber information, comprising the steps of: a) allowing the service user terminal of a service user to request the service-providing server to provide the online service and transmit personal information inputted by the service user; b) allowing the service-providing server to request the mobile communication subscriber information server to authenticate the service user in response to the online service request; c) allowing the mobile communication subscriber information server to retrieve mobile communication subscriber information in response to the service user authentication request and transmit an online service approval request message to a mobile communication terminal of a service-approving subscriber previously registered if the service user is a subscriber requiring a service approval of a third party; d) allowing the mobile communication subscriber information server to transmit an online service approval message to the service-providing server if the mobile communication subscriber information server receives the online service approval message from the mobile communication terminal of the service-approving subscriber; and e) allowing the service-providing server to provide the online service to the service user terminal if the service-providing server receives the online service approval message.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a configuration of an online service-providing system using a mobile communication terminal in which the present invention is applicable;

FIG. 2 is a view illustrating a procedure of providing an online service based on an approval procedure using a mobile communication terminal in accordance with an embodiment of the present invention;

FIG. 3 is a view illustrating a procedure of providing an online service based on an approval procedure using a mobile communication terminal in accordance with another embodiment of the present invention; and

FIG. 4 is a view illustrating a procedure of providing a radio payment service based on an approval procedure using a mobile communication terminal in accordance with an embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

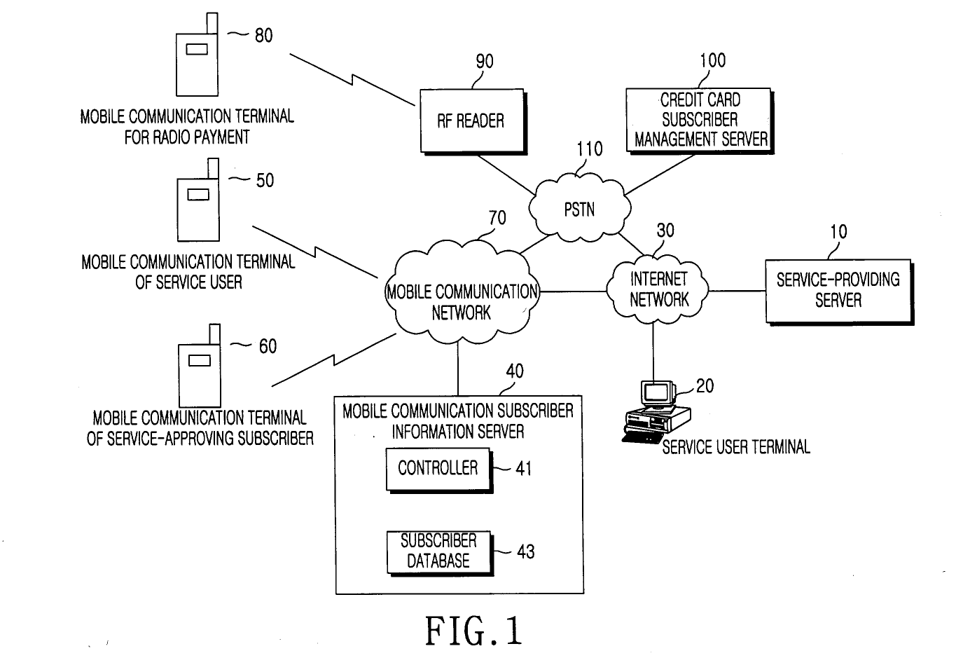

First, a description will be given of a configuration of a service system in which the present invention is applicable with reference to FIG. 1. FIG. 1 is a view illustrating a configuration of a service system for providing an online service on the Internet and a radio payment service using a mobile communication terminal in accordance with one embodiment of the present invention.

Referring to FIG. 1, the service system includes a service-providing server 10, a service user terminal 20, a mobile communication subscriber information server 40, an RF (Radio Frequency) reader 90, a credit card subscriber management server 100, a mobile communication network 70, an Internet network 30, a PSTN (Public Switched Telecommunications/Telephone network) 110, and a plurality of mobile communication terminals, i.e., a mobile communication terminal 50 of a service user, a mobile communication terminal 60 of a service-approving subscriber and a mobile communication terminal 80 for a radio payment.

The mobile communication terminal 50 of the service user is referred to as a conventional mobile communication terminal that the user has it for requesting an Internet online service in an embodiment of the present invention.

The mobile communication terminal 80 for the radio payment has an RF (Radio Frequency) chip identical to an RF chip mounted on a plastic credit card and a memory storing credit card information identical to credit card information stored in the plastic credit card. The mobile communication terminal 80 for the radio payment acts as the credit card in the radio payment service by transmitting the credit card information to the RF reader 90 using infrared rays.

The mobile communication terminal 60 of the service-approving subscriber in accordance with the embodiment of the present invention is a mobile communication terminal of a third party for deciding whether to approve an Internet online or radio payment service requested by a user, e.g., a minor.

The service-providing server 10 connected to the Internet network 30 is a service provider for providing an online service on the Internet. The online service includes all online services which can be provided to the service user when the service user has been connected to a website of the Internet. For example, the online services include an online product sale service, a chargeable information service, an electronic game service, etc.

The service user terminal 20 is connected to the service-providing server 10 through the Internet network 30. The service-providing server 10 provides the services to the service user terminal 20 through data communications. For example, the service-providing server 10 includes a personal computer, a notebook computer, etc.

The RF reader 90 is connected to the credit card subscriber management server 100 through the PSTN 110 and supports the radio payment service. The RF reader 90 radio-communicates with the mobile communication terminal 80 for the radio payment using infrared rays. The RF reader 90 has the same function as a general card reader, which receives the credit card information. Further, the RF reader 90 requests a payment service authentication by transmitting the credit card information received from the mobile communication terminal 80 for the radio payment to the credit card subscriber management server 100 through the PSTN 110.

The credit card subscriber management server 100 has credit card subscriber information, retrieves subscriber credit information in response to the payment service authentication request from the RF reader 90, determines a transaction approval and provides a credit card service. Where the service user requesting a transaction is a minor or a subscriber requiring a service approval of the third party, the credit card subscriber management server 100 requests the mobile communication subscriber information server 40 to approve the service. If the service approval is obtained from the mobile communication subscriber information server 40, the credit card service is provided.

The mobile communication subscriber information server 40 is connected to the mobile communication network 70 connected with the Internet network 30. The mobile communication subscriber information server 40 includes a controller 41 and a subscriber database 43. The subscriber database 43 stores mobile communication subscriber information and service-providing subscriber information in accordance with the embodiment of the present invention. The service-approving subscriber refers to the third party for determining the service approval where the service user requesting the service-providing server 10 to provide the service is a user, e.g., a minor, who can use the service only under the service approval by the third party. The service-approving subscriber may include a guardian of the service user, parents, a spouse, or etc.

The controller 41 controls an entire operation of the mobile communication subscriber information server 40, retrieves subscriber information of the subscriber database 43 in response to an external request and provides the retrieved subscriber information. In accordance with an embodiment of the present invention, the controller 41 controls an entire process according to an authentication request from the service user. In other words, if the controller 41 receives the authentication request of the service user from the service-providing server 10, it retrieves corresponding subscriber information from the subscriber database 43. Where the service user is a subscriber requiring a service approval of the third party, a short message requesting the service approval along with service contents is provided to the mobile communication terminal 60 of the service-approving subscriber previously registered through the mobile communication network 70. Accordingly, the service-approving subscriber transmits a service approval message or a service rejection message through the mobile communication terminal 60. Where the controller 41 of the mobile communication subscriber information server 40 receives the service approval message, the controller 41 generates an authentication number to transmit it to the service user terminal 20 and the service-providing server 10 in accordance with an embodiment of the present invention. Alternatively, the controller 41 transmits a service approval message to the service-providing server 10 in accordance with another embodiment of the present invention. If the controller 41 receives the service rejection message, it transmits a service unavailable message to the service-providing server 10.

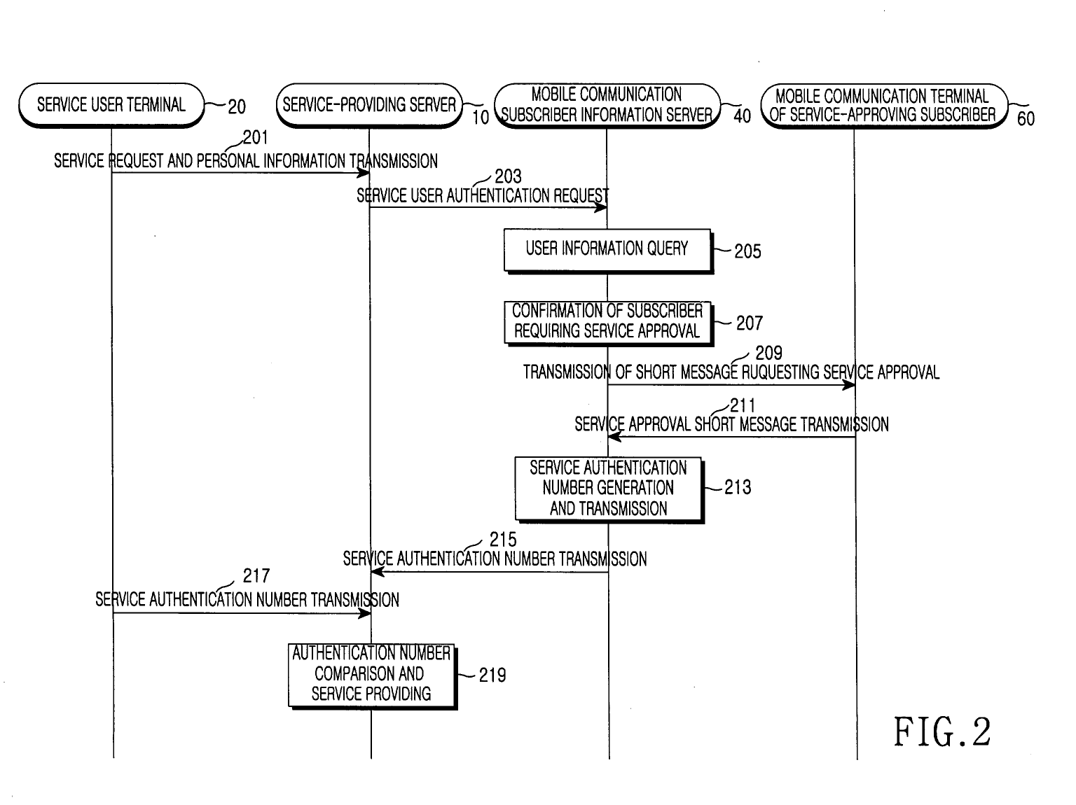

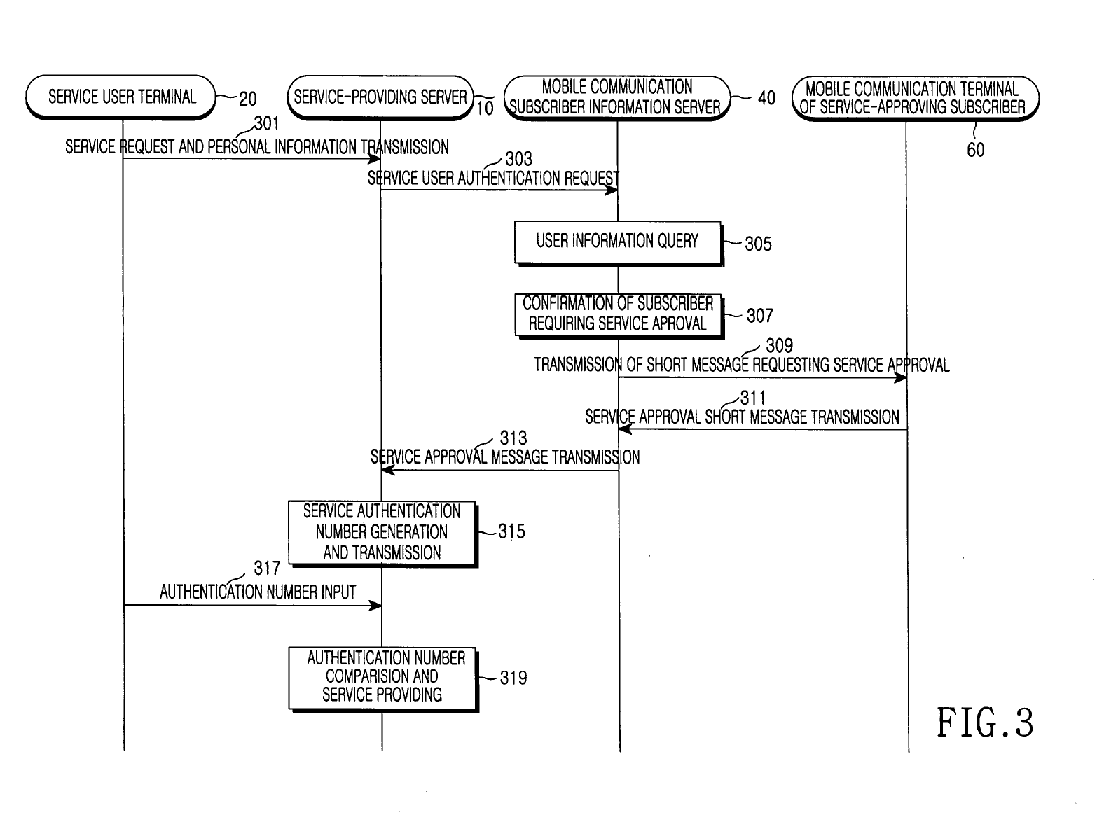

The online service system determines whether the online service must be provided to the service user on the basis of the service approval procedure of the mobile communication subscriber information server 40. A service-providing procedure will be described with reference to FIGS. 2 and 3. FIG. 2 is a view illustrating a procedure of providing an online service based on an approval procedure using a mobile communication terminal in accordance with an embodiment of the present invention. FIG. 3 is a view illustrating a procedure of providing an online service based on an approval procedure using a mobile communication terminal in accordance with another embodiment of the present invention.

Referring to FIG. 2, the service user terminal 20 of an online service user requests the service-providing server 10 to provide the online service through the Internet network and transmits personal information inputted from the service user to the service-providing server 10 at step 201. Accordingly, the service-providing server 10 requests an authentication of the service user by transmitting the personal information received from the service user terminal 20 along with a type of an online service to the mobile communication subscriber information server 40 at step 203. In response to the service user authentication request from the service-providing server 10, the mobile communication subscriber information server 40 retrieves the subscriber database 43 and queries user information at step 205 and then proceeds to step 207. At the above step 207, the mobile communication subscriber information server 40 identifies the subscriber information associated with the service user and determines whether the service user is a subscriber requiring a service approval of a third party. At this time, if the service user is not a subscriber requiring a service approval of a third party, the mobile communication subscriber information server 40 generates a service authentication number and transmits the generated service authentication number to the service-providing server 10 and the mobile communication terminal 50 of the service user. And, the user checks the service authentication number through the mobile communication terminal 50 of the service user and inputs it to the service user terminal 20. And then, the service user terminal 20 transmits the service authentication number to the service-providing server 10. Thereafter, if the service-providing server 10 receiving the service authentication number from the mobile communication subscriber information server 40 receives another authentication number from the service user terminal 20, it determines whether the service authentication number received from the mobile communication subscriber information server 40 is the same as another authentication number received from the service user terminal 20. If the service authentication number received from the mobile communication subscriber information server 40 is the same as another authentication number received from the service user terminal 20, the service-providing server 10 provides the online service.

On the other hand, if the mobile communication subscriber information server 40 determines at the above step 207 that the service user is a subscriber requiring a service approval of a third party, it retrieves an identification number of a mobile communication terminal previously registered corresponding to the service-approving subscriber associated with the service user. The mobile communication subscriber information server 40 transmits a short message requesting the service approval including the contents of the online service through the mobile communication network 70 at step 209. If the mobile communication subscriber information server 40 receives a service approval short message from the mobile communication terminal 60 of the service-approving subscriber within a predetermined period of time at step 211, it proceeds to step 213. At this time, if the mobile communication subscriber information server 40 fails to receive the service approval short message from the mobile communication terminal 60 of the service-approving subscriber or receives a service unavailable message, it transmits the service unavailable message to the service-providing server 10.

The mobile communication subscriber information server 40 generates the service authentication number and then transmits the generated service authentication number to the mobile communication terminal 50 of the service user at the above step 213. Thereafter, the mobile communication subscriber information server 40 proceeds to step 215. The mobile communication subscriber information server 40 transmits the service authentication number to the service-providing server 10 at the above step 215. If the service-providing server 10 receiving the service authentication number from the mobile communication subscriber information server 40 receives another service authentication number from the service user terminal 20 at step 217, it proceeds to step 219. The service authentication number generated by the mobile communication subscriber information server 40 is transmitted to the mobile communication terminal 50 of the service user in a short message form through the mobile communication network at the step 213. The user who requested service checks the service authentication number, which the service authentication number received in a short message form is displayed on LCD, and inputs the service authentication number to the service user terminal 20 such as personal computer. The service-providing server 10 compares the two service authentication numbers and then provides the online service if the two service authentication numbers match each other at the above step 219.

A procedure of providing an online service based on an approval procedure using a mobile communication terminal in accordance with another embodiment of the present invention will be described with reference to FIG. 3. The service user terminal 20 of an online service user requests the service-providing server 10 to provide the online service through the Internet network 30 and transmits personal information inputted from the service user to the service-providing server 10 at step 301. Accordingly, the service-providing server 10 requests an authentication of the service user by transmitting the personal information received from the service user terminal 20 along with a type of an online service to the mobile communication subscriber information server 40 at step 303. In response to the service user authentication request from the service-providing server 10, the mobile communication subscriber information server 40 retrieves the subscriber database 43 and queries user information at step 305, and then proceeds to step 307. At the above step 307, the mobile communication subscriber information server 40 identifies the subscriber information of the service user and determines whether the service user is a subscriber requiring a service approval of a third party. At this time, if the service user is not a subscriber requiring a service approval of a third party, the mobile communication subscriber information server 40 generates a service authentication number and transmits the generated service authentication number to the service-providing server 10.

On the other hand, if the mobile communication subscriber information server 40 determines at the above step 307 that the service user is a subscriber requiring a service approval of a third party, it retrieves an identification number of a mobile communication terminal previously registered corresponding to the service-approving subscriber associated with the service user. The mobile communication subscriber information server 40 transmits a short message requesting the service approval including the contents of the online service through a mobile communication network at step 309. If the mobile communication subscriber information server 40 receives a service approval message from the mobile communication terminal 60 for the service-approving subscriber within a predetermined period of time at step 311, it proceeds to step 313. At this time, if the mobile communication subscriber information server 40 fails to receive the service approval message or receives a service unavailable message, it transmits the service unavailable message to the service-providing server 10.

The mobile communication subscriber information server 40 transmits a service approval message to the service-providing server 10 at the above step 313. The service-providing server 10 receiving the service approval message generates the service authentication number and then transmits the generated service authentication number to the mobile communication terminal 50 for the service user at step 315. Thereafter, the service-providing server 10 receives another authentication number from the service user terminal 20 at step 317 and then proceeds to step 319. The service authentication number generated by the mobile communication subscriber information server 40 is transmitted to the mobile communication terminal 50 of the service user in a short message form through the mobile communication network. The user who requested service checks the service authentication number, which the service authentication number received in a short message form is displayed on LCD, and inputs the service authentication number to the service user terminal 20 such as personal computer. At the above step 319, the service-providing server 10 compares the service authentication number generated at the above step 315 with another authentication number received at the above step 317. If the two authentication numbers match each other, the service-providing server 10 provides the online service to the service user terminal 20.

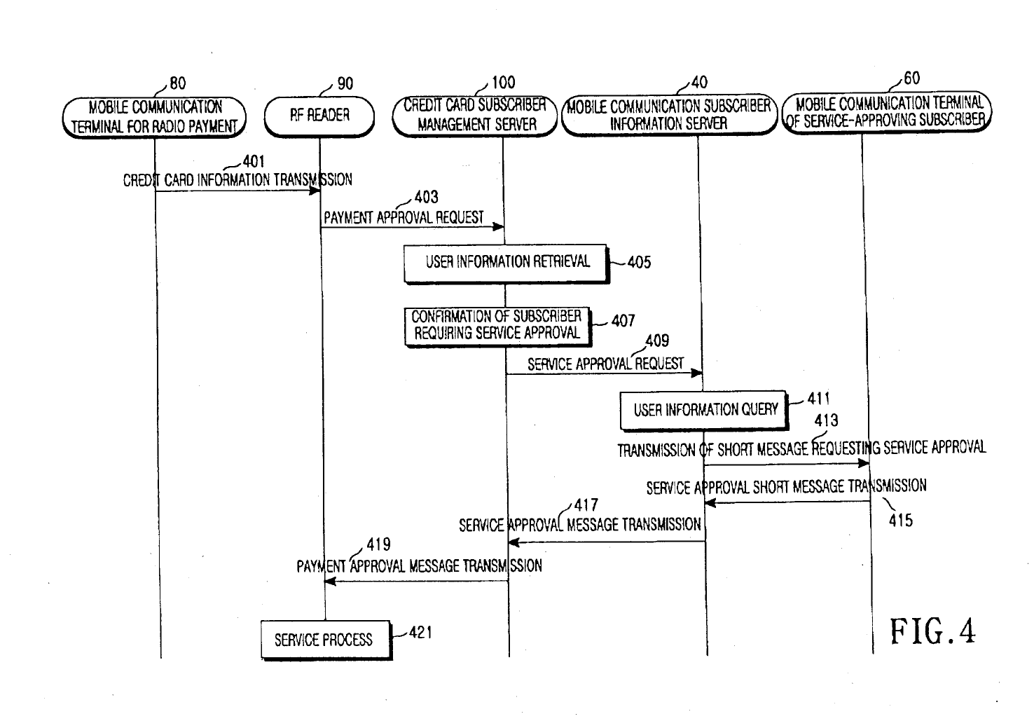

Next, an authentication procedure when a radio payment service is provided will be described with reference to FIG. 4. FIG. 4 is a view illustrating a procedure of providing a radio payment service based on an approval procedure using a mobile communication terminal in accordance with an embodiment of the present invention.

The mobile communication terminal 80 for the radio payment transmits stored credit card information to the RF reader 90 using infrared rays at step 401 so that the radio payment service can be approved. Accordingly, the RF reader 90 requests a payment approval by transmitting the credit card information received from the mobile communication terminal 80 for the radio payment to the credit card subscriber management server 100 at step 403. In response to the payment approval request from the RF reader 90, the credit card subscriber management server 100 retrieves credit card subscriber database and queries subscriber information of the service user at step 405, and then proceeds to step 407. At the above step 407, the credit card subscriber management server 100 identifies the subscriber information of the service user and then determines whether the service user is a subscriber requiring a service approval of a third party. At this time, if the service user is not a subscriber requiring a service approval of a third party, the credit card subscriber management server 100 transmits a payment approval message to the RF reader 90. Thereafter, the RF reader 90 receiving the payment approval message carries out a corresponding service procedure.

On the other hand, if the credit card subscriber management server 100 determines that the service user is a subscriber requiring a service approval of a third party, it transmits a service approval request message along with an identification number of a mobile communication terminal of the service user to the mobile communication subscriber information server 40 at step 409. The mobile communication subscriber information server 40 receiving the service approval request message queries user information and retrieves an identification number of a mobile communication terminal of the service-approving subscriber associated with the service user at step 411 and then proceeds to step 413. The mobile communication subscriber information server 40 transmits a service approval request message requesting a service contents approval to the mobile communication terminal 60 of the service-approving subscriber. If the mobile communication subscriber information server 40 receives the service approval message from the mobile communication terminal 60 of the service-approving subscriber within a predetermined period of time at step 415, it proceeds to step 417. At this time, if the mobile communication subscriber information server 40 fails to receive the service approval message within the predetermined period of time or receives a service unavailable message, it transmits the service unavailable message to the credit card subscriber management server 100.

If the mobile communication subscriber information server 40 receives the service approval message from the mobile communication terminal 60 of the service-approving subscriber within a predetermined period of time at the above step 415, it transmits a service approval message to the credit card subscriber management server 100 at the above step 417. The credit card subscriber management server 100 receiving the service approval message from the mobile communication subscriber information server 40, and transmits a payment approval message to the RF reader 90 at step 419. The RF reader 90 receiving the payment approval message carries out a corresponding service procedure.

As apparent from the above description, the present invention provides a method for providing an online service to a minor under approval from a guardian of the minor, thereby preventing the minor from accessing harmful information or excessively using a chargeable service.

Although the preferred embodiments of the present invention have been disclosed for illustrative purposes, those skilled in the art will appreciate that various modifications, additions and substitutions are possible, without departing from the scope of the invention. For example, although a procedure of identifying a service-approving subscriber and retrieving subscriber information in a radio payment service in accordance with the present invention is performed by a mobile communication subscriber information server, a credit card subscriber management server can be configured in another embodiment of the present invention so that it stores information associated with the service-approving subscriber, retrieves corresponding information and transmits a service approval request message. Therefore, the present invention is not limited to the above-described embodiments, but the present invention is defined by the claims, which follow, along with their full scope of equivalents.

What is claimed is:

1. An authentication method for providing an online service using a mobile communication terminal in an online service system, the online service system including a service-providing server connected to an Internet network for providing the online service, a service user terminal connected to the Internet network for requesting the service-providing server to provide the online service and using the online service provided from the service-providing server, and a mobile communication subscriber information server connected to a mobile communication network connected the Internet network for storing mobile communication subscriber information, comprising:
a) allowing the service user terminal of a service user to request the service-providing server to provide the online service and transmit personal information inputted by the service user;
b) allowing the service-providing server to request the mobile communication subscriber information server to authenticate the service user in response to the online service request;
c) allowing the mobile communication subscriber information server to retrieve mobile communication subscriber information in response to the service user authentication request and transmit an online service approval request message to a mobile communication terminal of a service-approving subscriber previously registered if the service user is a subscriber requiring a service approval of a third party;
d) allowing the mobile communication subscriber information server to transmit an online service approval message to the service-providing server if the mobile communication subscriber information server receives the online service approval message from the mobile communication terminal of the service-approving subscriber; and
e) allowing the service-providing server to provide the online service to the service user terminal if the service-providing server receives the online service approval message.

2. The authentication method as set forth in claim 1, wherein the step e) comprises the steps of:
e1) allowing the service-providing server to generate an authentication number and transmit the generated authentication number to a mobile communication terminal of the service user;
e2) allowing the service-providing server to receive another authentication number from the service user terminal; and
e3) allowing the service-providing server to provide the online service to the service user terminal if the generated authentication number and the received authentication number are equal.

3. An authentication method for providing an Internet online service using a mobile communication terminal in an online service system, the online service system including a service-providing server connected to an Internet network for providing the online service, a service user terminal connected to the Internet network for requesting the service-providing server to provide the online service and using the online service provided from the service-providing server, and a mobile communication subscriber information server connected to a mobile communication network connected to the Internet network for storing mobile communication subscriber information, comprising:
a) allowing the service user terminal of a service user to request the service-providing server to provide the online service and transmit personal information inputted by the service user;
b) allowing the service-providing server to request the mobile communication subscriber information server to authenticate the service user in response to the online service request;
c) allowing the mobile communication subscriber information server to retrieve mobile communication subscriber information in response to the service user authentication request and transmit an online service approval request message to a mobile communication terminal of a service-approving subscriber previously registered if the service user is a subscriber requiring a service approval of a third party;
d) allowing the mobile communication subscriber information server to generate an authentication number if the mobile communication subscriber information server receives an online service approval message from the mobile communication terminal of the service-approving subscriber and transmit the authentication number to a mobile communication terminal of the service user and the service-providing server; and
e) after the service-providing server receives another authentication number from the service user terminal, allowing the service-providing server to compare said another authentication number received from the service user terminal with the authentication number received from the mobile communication subscriber information server and provide the online service to the service user terminal if the two authentication numbers are equal.

4. An authentication method for providing a radio payment service using a mobile communication terminal in a radio payment service system, the radio payment service system including a mobile communication terminal for storing credit card information, an RF (Radio Frequency) reader connected to a credit card subscriber server for communicating with the mobile communication terminal by radio and requesting a payment approval, a credit card subscriber management server having credit card subscriber information for deciding the payment approval in response to the payment approval request, and a mobile communication subscriber information server for storing mobile communication subscriber information, comprising:
a) allowing the mobile communication terminal to transmit the credit card information to the RF reader;
b) allowing the RF reader to request the payment approval by transmitting the credit card information to the credit card subscriber management server;
c) allowing the credit card subscriber management server to retrieve the credit card subscriber information in response to the payment approval request and transmit a service approval request to the mobile communication subscriber information server if a service user is a subscriber requiring a service approval of a third party;
d) allowing the mobile communication subscriber information server to retrieve the mobile communication subscriber information in response to the service approval request and transmit an online service approval request message to a mobile communication terminal of a service-approving subscriber;
e) allowing the mobile communication subscriber information server to transmit a service approval message to the credit card subscriber management server if the mobile communication subscriber information server receives the service approval message from the mobile communication terminal of the service-approving subscriber; and
f) allowing the credit card subscriber management server to transmit a payment approval message to the RF reader if the credit card subscriber management server receives the service approval message.
